(19) United States
(12) Patent Application Publication
(10) Pub. No.: US 2014/0286624 A1
(43) Pub. Date: Sep. 25, 2014

(54) METHOD AND APPARATUS FOR PERSONALIZED MEDIA EDITING

(71) Applicant: NOKIA CORPORATION, Espoo (FI)

(72) Inventors: Antti Johannes Eronen, Tampere (FI); Arto Juhani Lehtiniemi, Lempaala (FI); Juha Henrik Arrasvuori, Tampere (FI); Jukka Antero Holm, Tampere (FI)

(73) Assignee: NOKIA CORPORATION, Espoo (FI)

(21) Appl. No.: 13/849,744

(22) Filed: Mar. 25, 2013

(51) Int. Cl. G11B 27/028; H04N 9/87

(52) U.S. Cl. CPC G11B 27/028; H04N 9/87
USPC 386/278

(57) ABSTRACT

A method, apparatus, and computer program product are disclosed to generate a media compilation based on content generated from a community of users. In the context of a method, input that visually simulates a desired type of content is received. The method includes identifying content that matches the input and generating a media compilation based on the identified content.

### TECHNOLOGICAL FIELD

Example embodiments of the present invention relate generally to media editing and, more particularly, to a method and apparatus for personalizing automatically generated media compilations.

### BACKGROUND

Crowd sourced video services generate video clips and slideshows from user-generated content. In particular, a video service collects original video and image content from a variety of users attending at an event. After collecting the video and image content, the video service may automatically splice together the content to generate a professional looking media compilation. A typical scenario is as follows: a crowd of users go to a concert. During the concert, the users capture video of the event. After the concert, the content is uploaded to the service. The service then creates an automatic cut or compilation of the video clips generated by the users.

Although media compilations can be generated based on user-generated content, because automation is often a goal of these video services, personalization of the content and transition effects used in an automatically generated media compilation is not traditionally possible.

### BRIEF SUMMARY

A method, apparatus, and computer program product are provided in accordance with an example embodiment that enables personalized media editing. In an example embodiment, a method, apparatus and computer program product are provided to receive user input to enable user-customization of content and transition effects used in automatically generated media compilations.

In a first example embodiment, a method is provided that includes receiving input that visually simulates a desired type of content. The method identifies content that matches the input and generates a media compilation based on the identified content.

In some embodiments, identifying content that matches the input includes at least one of comparing the input to content stored in a content catalog and identifying content that matches the input includes determining a keyword associated with the input based on an analysis of the input, and identifying content that has previously been associated with the keyword.

In some embodiments, comparing the input to content stored in the content catalog includes extracting features from the input, and comparing the distances between the features of the input and features extracted from the content stored in the content catalog. In another embodiment, the method further includes receiving an indication of a duration of a frame in the media compilation.

The desired type of content may comprise a shot type, a number of people appearing in a shot, a primary shape of an object that appears in a shot, or a transition effect. The input may comprise a sketch drawn by a user or a captured image. The media compilation may comprise a video remix, a slideshow, or a combination of both.

In another example embodiment, an apparatus is provided having at least one processor and at least one memory including computer program code with the at least one memory and the computer program code configured to, with the at least one processor, cause the apparatus to receive input that visually simulates a desired type of content, identify content that matches the input, and generate a media compilation based on the identified content.

In some embodiments, the at least one memory and the computer program code are configured to, with the at least one processor, cause the apparatus to identify content that matches the input by at least one of comparing the input to content stored in a content catalog and determining a keyword associated with the input based on an analysis of the input, and identifying content that has previously been associated with the keyword.

In some embodiments, the at least one memory and the computer program code are configured to, with the at least one processor, cause the apparatus to compare the input to content stored in the content catalog by extracting features from the input, and compare the distances between the features of the input and features extracted from the content stored in the content catalog. In another embodiment, the at least one memory and the computer program code are configured to, with the at least one processor, cause the apparatus to receive an indication of a duration of a frame in the media compilation.

The desired type of content may comprise a shot type, a number of people appearing in a shot, a primary shape of an object that appears in a shot, or a transition effect. The input may comprise a sketch drawn by a user or a captured image. The media compilation may comprise a video remix, a slideshow, or a combination of both.

In another example embodiment, a computer program product is provided that includes at least one non-transitory computer-readable storage medium having computer-executable program code portions stored therein with the computer-executable program code portions comprising program code instructions that, when executed, cause an apparatus to receive input that visually simulates a desired type of content, identify content that matches the input, and generate a media compilation based on the identified content.

In some embodiments, the computer program product further comprises program code instructions that, when executed, cause the apparatus to identify content that matches the input by at least one of comparing the input to content stored in a content catalog and determining a keyword associated with the input based on an analysis of the input, and identifying content that has previously been associated with the keyword.

In some embodiments, the computer program product further comprises program code instructions that, when executed, cause the apparatus to compare the input to content stored in the content catalog by extracting features from the input, and compare the distances between the features of the input and features extracted from the content stored in the content catalog. In another embodiment, the computer program product further comprises program code instructions that, when executed, cause the apparatus to receive an indication of a duration of a frame in the media compilation.

The desired type of content may comprise a shot type, a number of people appearing in a shot, a primary shape of an object that appears in a shot, or a transition effect. The input may comprise a sketch drawn by a user or a captured image. The media compilation may comprise a video remix, a slideshow, or a combination of both.

In another example embodiment, an apparatus is provided that includes means for receiving input that visually simulates a desired type of content. The apparatus further includes means for identifying content that matches the input and means for generating a media compilation based on the identified content.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments of the present disclosure in general terms, reference will now be made to the accompanying drawings, which are not necessarily drawn to scale, and wherein:

FIG. 1 shows a block diagram of an apparatus that may be specifically configured in accordance with an example embodiment of the present invention;

FIG. 2 shows an example of user sketch input for personalizing content in a media compilation, in accordance with some embodiments;

FIG. 3 shows an example of user input for personalizing content and selecting a perspective in a media compilation, in accordance with some embodiments;

FIG. 4 shows an example of user keyword input for personalizing content in a media compilation, in accordance with some embodiments;

FIG. 5 shows example user sketch input for personalizing transition effects, in accordance with some embodiments;

FIG. 6 illustrates a flowchart describing example operations for generating a personalized media compilation, in accordance with some example embodiments;

FIG. 7 illustrates a flowchart describing example operations for identifying content that matches user input, in accordance with some example embodiments; and

FIG. 8 illustrates a flowchart describing example operations for comparing input to content stored in a content catalog, in accordance with some example embodiments.

### DETAILED DESCRIPTION

Some embodiments of the present invention will now be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout. As used herein, the terms “data,” “content,” “information,” and similar terms may be used interchangeably to refer to data capable of being transmitted, received, and/or stored in accordance with embodiments of the present invention. Thus, use of any such terms should not be taken to limit the spirit and scope of embodiments of the present invention.

Additionally, as used herein, the term “circuitry” refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of “circuitry” applies to all uses of this term herein, including in any claims. As a further example, as used herein, the term “circuitry” also includes an implementation comprising one or more processors and/or portion(s) thereof and accompanying software and/or firmware. As another example, the term “circuitry” as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

A method, apparatus, and computer program product are provided in accordance with an example embodiment of the present invention in order to generate elementary string sets for unit testing regular expressions. As such, the method, apparatus, and computer program product may be embodied by any of a variety of devices. For example, the devices may include any of a variety of mobile terminals, such as a portable digital assistant (PDA), mobile telephone, smartphone, mobile television, gaming device, laptop computer, camera, tablet computer, video recorder, web camera, or any combination of the aforementioned devices. Additionally or alternatively, the computing device may include fixed computing devices, such as a personal computer or a computer workstation. Still further, the method, apparatus, and computer program product of an example embodiment may be embodied by a networked device, such as a server or other network entity, configured to communicate with one or more devices, such as one or more client devices.

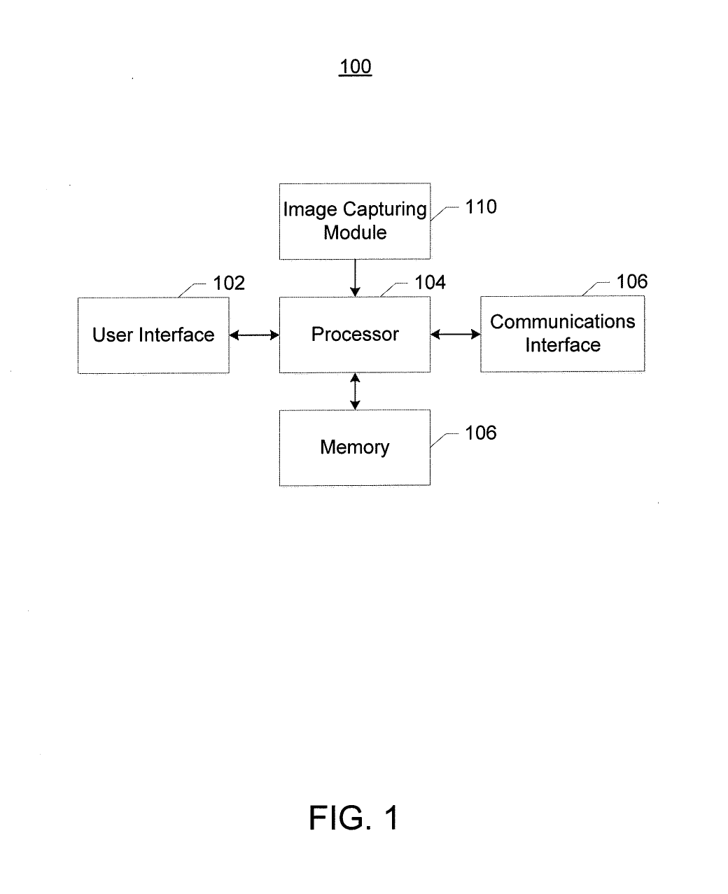

Regardless of the type of device, an apparatus 100 that may be specifically configured to enable personalized media editing, such as in an automatic or semi-automatic manner, in accordance with an example embodiment is illustrated in FIG. 1. In this regard, users attending an event may each use an apparatus 100 to capture or otherwise receive video and image content. Additionally or alternatively, each apparatus 100 may be used to perform operations that create a media compilation based on video and image content captured locally or provided by other users. It should be noted that while FIG. 1 illustrates one example configuration, numerous other configurations may also be used to implement embodiments of the present invention. As such, in some embodiments, although elements are shown as being in communication with each other, hereinafter such elements should be considered to be capable of being embodied within the same device or within separate devices.

Referring now to FIG. 1, the apparatus 100 may include or otherwise be in communication with a processor 104, a memory device 108, and optionally a communication interface 106, a user interface 102, and/or an image capturing module 110. In some embodiments, the processor (and/or co-processor or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like, for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

The apparatus 100 may be embodied by a computing device, such as a computer terminal. However, in some embodiments, the apparatus may be embodied as a chip or chip set. In other words, the apparatus may comprise one or more physical packages (e.g., chips) including materials, components, and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 104 may be embodied in a number of different ways. For example, the processor may be embodied as one or more of various hardware processing means such as a co-processor, a microprocessor, a controller, a digital signal processor (DSP), a processing element with or without an accompanying DSP, or various other processing circuitry including integrated circuits such as, for example, an ASIC (application specific integrated circuit), an FPGA ((field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining, and/or multithreading.

In an example embodiment, the processor 104 may be configured to execute instructions stored in the memory device 108 or otherwise accessible to the processor. Alternatively or additionally, the processor may be configured to execute hard-coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA, or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a pass-through display or a mobile terminal) configured to employ an embodiment of the present invention by further configuration of the processor by instructions for performing the algorithms and/or operations described herein. The processor may include, among other things, a clock, an arithmetic logic unit (ALU), and logic gates configured to support operation of the processor.

Meanwhile, the communication interface 106 may be any means such as a device or circuitry embodied in either hardware or a combination of hardware and software that is configured to receive and/or transmit data from/to a network and/or any other device or module in communication with the apparatus 100. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may additionally or alternatively support wired communication. As such, for example, the communication interface may include a communication modem and/or other hardware/software for supporting communication via cable, digital subscriber line (DSL), universal serial bus (USB), or other mechanisms.

In some embodiments, the apparatus 100 may include a user interface 102 that may, in turn, be in communication with processor 104 to provide output to the user and, in some embodiments, to receive an indication of a user input. As such, the user interface may include a display and, in some embodiments, may also include a keyboard, a mouse, a joystick, a touch screen, touch areas, soft keys, a microphone, a speaker, or other input/output mechanisms. Alternatively or additionally, the processor may comprise user interface circuitry configured to control at least some functions of one or more user interface elements such as a display and, in some embodiments, a speaker, ringer, microphone, and/or the like. The processor and/or user interface circuitry comprising the processor may be configured to control one or more functions of one or more user interface elements through computer program instructions (e.g., software and/or firmware) stored on a memory accessible to the processor (e.g., memory device 14, and/or the like).

As shown in FIG. 1, the apparatus 100 may also include an image capturing module 110, such as a camera, video and/or audio module, in communication with the processor 104. The image capturing element may be any means for capturing an image, video and/or audio for storage, display or transmission. As used herein, an image includes a still image as well as an image from a video recording. For example, in an example embodiment in which the image capturing element is a camera, the camera may include a digital camera capable of forming a digital image file from a captured image. As such, the camera may include all hardware (for example, a lens or other optical component(s), image sensor, image signal processor, and/or the like) and software necessary for creating a digital image file from a captured image. Alternatively, the camera may include only the hardware needed to view an image, while the memory 108 of the apparatus stores instructions for execution by the processor in the form of software necessary to create a digital image file from a captured image. In an example embodiment, the camera may further include a processing element such as a co-processor which assists the processor in processing image data and an encoder and/or decoder for compressing and/or decompressing image data. The encoder and/or decoder may encode and/or decode according to, for example, a joint photographic experts group (JPEG) standard, a moving picture experts group (MPEG) standard, or other format.

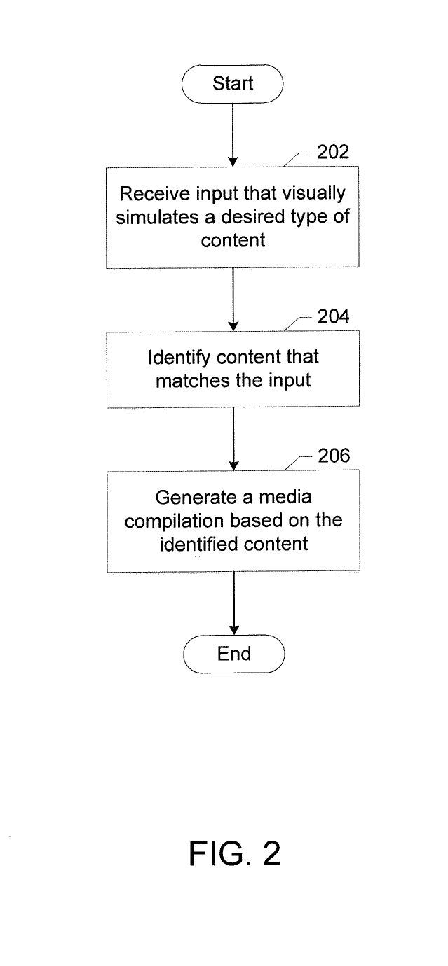

FIG. 2 illustrates a flowchart containing a series of operations performed to generate and personalize a media compilation, such as, for example, a video remix or a slideshow or a combination of both. The content used to generate the media compilation may be identified using by searching a content catalog, which stores video, image, and transition effects content. In this regard, the content catalog may reside on the apparatus 100 generating the media compilation, or on an online server or other repository. In one embodiment, the content catalog may include the video and image content stored on devices reachable by apparatus 100 (such as, for example, a set of mobile devices with which the apparatus 100 can communicate). The content catalog may be generated using a content processing module executed by devices that capture content, an online server storing the content catalog, the apparatus 100 that generates the media compilation or some combination thereof. The content processing module may analyze the content for visual features which allow matching to user created sketches. In particular, the content processing module may execute video key frame extraction and may run or otherwise execute an edge detection method for still images and video key frames in the content catalog.

The operations illustrated in FIG. 2 may, for example, be performed by, with the assistance of, and/or under the control of one or more of processor 104, memory 108, user interface 102, communications interface 106, or image capturing module 110. In operation 202, the apparatus 100 includes means, such as processor 104, user interface 102, communications interface 106, image capturing module 110, or the like, for receiving input that visually simulates a desired type of content. In this manner, the user is able to intuitively enter personalizing instructions for interpretation by the apparatus 100.

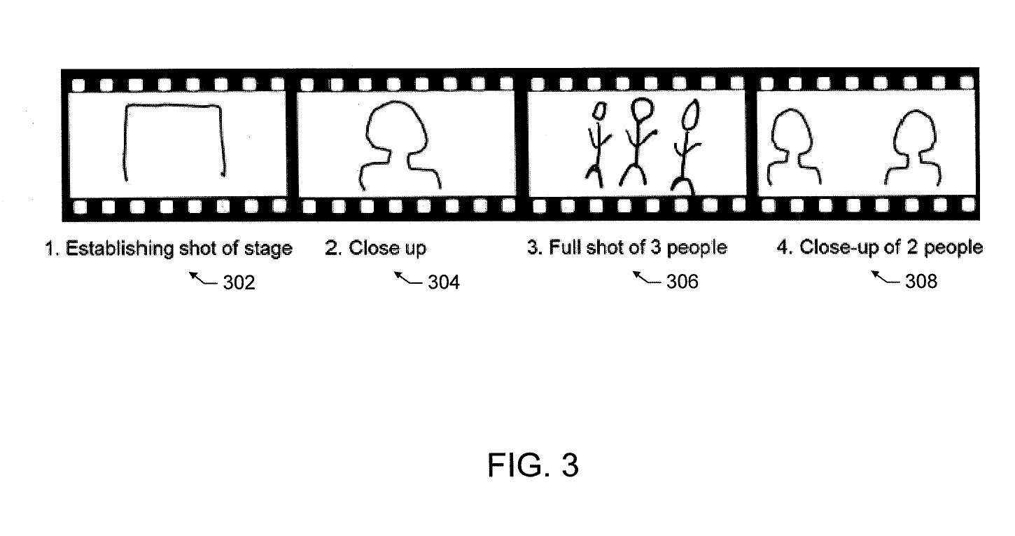

For instance, the apparatus 100 may include means, such as processor 104, user interface 102, communications interface 106, or the like, for enabling the user to draw a sketch that visually simulates the types of content that the user desires. In this regard, user interface 102 may comprise a touch screen, and the apparatus 100 may include software that detects user strokes on the touch screen. The sketch may represent each camera angle to be included in the media compilation. FIG. 3 illustrates an example sketch provided by a user to the apparatus 100 for generating a personalized media compilation. In this example, for each frame of the media compilation that will be generated, the user-provided sketch may define the shot type (e.g., establishing shot 302, close-up 304, full shot 306, and mid-shot 308), the number of people appearing in the shot (e.g., shots 304, 306, and 308), the primary shape of an object appearing in the shot (e.g., shot 302), a background image to be displayed in a media compilation, or any other personalizing information.

In one alternative embodiment, rather than having the user draw a sketch, the apparatus 100 may include means, such as processor 104, user interface 102 or the like, for presenting a set of template shot types available behind, for example, a pull-down menu. The template shots may depict the establishing shot as a picture (picture of a stage, picture of single player, picture of singer, picture of several players). The user may drag and drop these template shots on a similar timeline as below. The functionality is otherwise similar as disclosed above.

In another embodiment, the apparatus 100 may include means, such as processor 104, user interface 102 or the like, for enabling the user to use his or her own still images captured from an event (such as a concert) as sketches for the shots (e.g., an image of the whole stage of a performance may be used as the establishing shot). Similarly, the user may take pictures (or select existing pictures from a gallery) with the device camera to indicate a desired sketch of the shots (e.g., a picture of a person may indicate that the user requests content of a single performer, a picture of two persons may indicate that the user requests content of two performers, etc.).

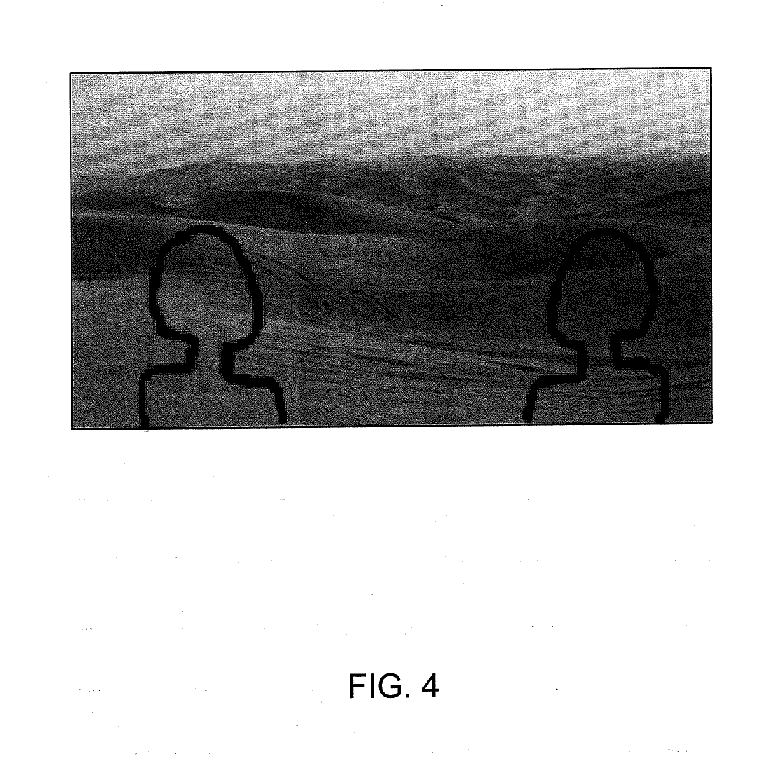

In yet another embodiment, the apparatus 100 may include means, such as processor 104, user interface 102 or the like, for providing the user with a map, such as a multidimensional map, e.g., a three dimensional (3D) map (e.g., from the Nokia City Scene™ mapping service) of the location where an event has been filmed. The location may be provided by device(s) hosting the content catalog (for instance, the devices capturing the content may have provided the global positioning system (GPS) coordinates as metadata connected to the content). The user selects a vantage point from the map to the location and draws the sketch on top of the map (or Street View™ type map) image, as shown in FIG. 4. A video angle with a close-enough matching shape and matching background is retrieved and included in the final video remix. This operation may also be used to search for desired segments from a long video clip.

A background image may also be obtained by, for example, the processor 104, the user interface 102 or the like using a screen capture from existing video content or it may be selected from a photo album. If the chosen background image has been tagged in metadata with location coordinates, the apparatus 100, such as the processor 102, may obtain the GPS coordinates and heading information and may use this information to find a matching shot.

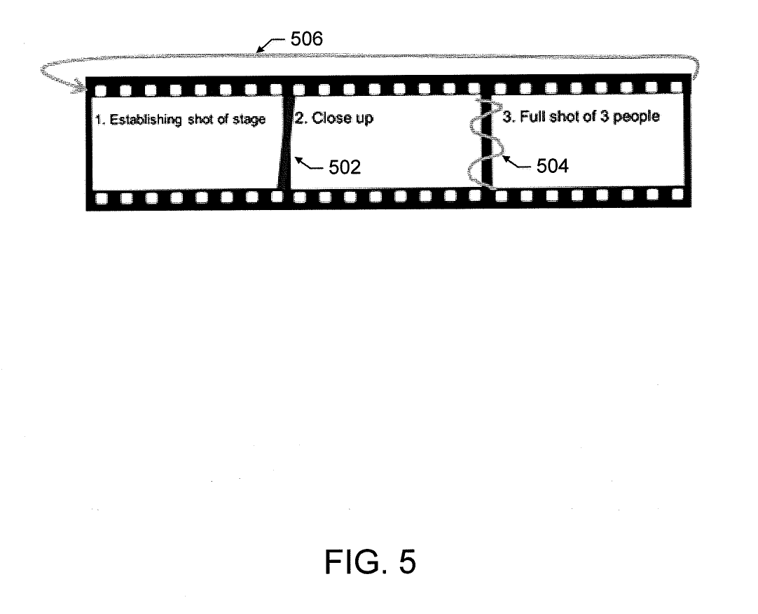

In addition, the apparatus 100 may include means, such as processor 104, user interface 102 or the like, for receiving input simulating desired content such as effects to be used between scene transitions. For instance, the user may draw indications of desired effects between scene transitions, which may be interpreted by the processor to provide the desired effects. As illustrated in FIG. 5, a user drawing a sharp line (502) between two shot sketches indicates that the transition from two frames should be sharp, whereas a scribble or a blurry line (504) between shot sketches indicates that a smooth/blended transition should be made. Also a loop point arrow (506) may be drawn to indicate a sequence of shot types that will be repeated a number of times defined by the user.

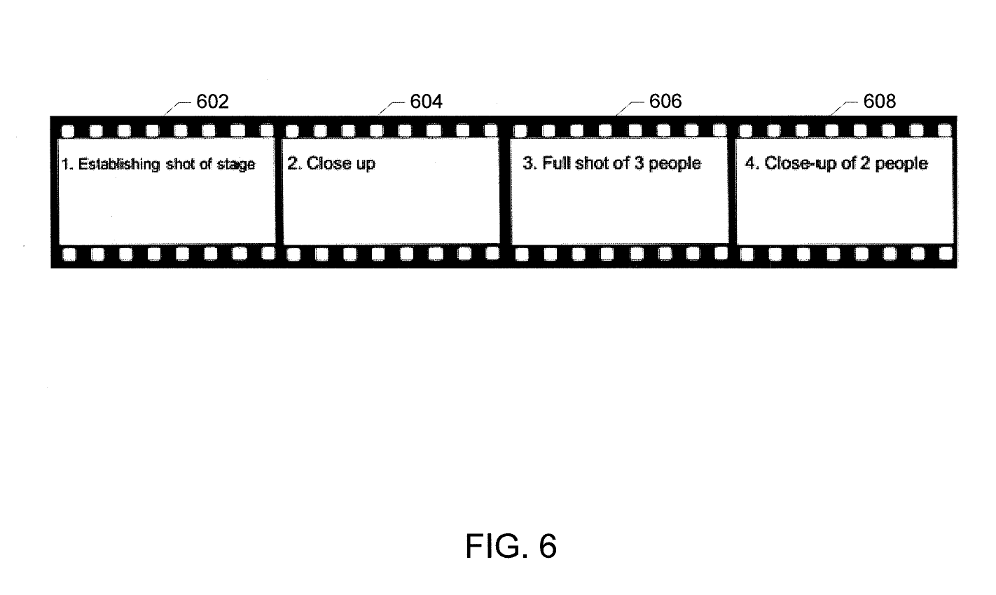

In one alternative embodiment, rather than receiving input that visually simulates a desired type of content, the apparatus 100 may include means, such as processor 104, user interface 102 or the like, for receiving keyword input from the user that describes the desired contents in each selected camera angle. For example, as illustrated in FIG. 6, shots 602, 604, 606, and 608 are defined in the interface by film frame icons. The apparatus 100 may include means, such as processor 104, user interface 102 or the like, for providing the user with a template with which to enter the desired camera angle contents corresponding to each of the shots. For each frame, a set of matching content may then be populated from the content catalog and the user may then select the desired frame content from a pull-down menu.

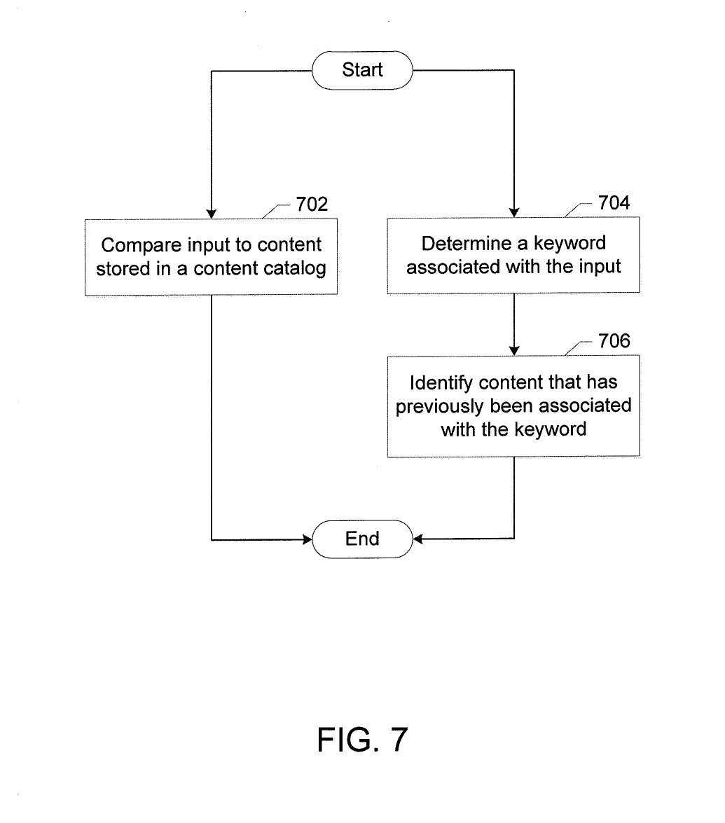

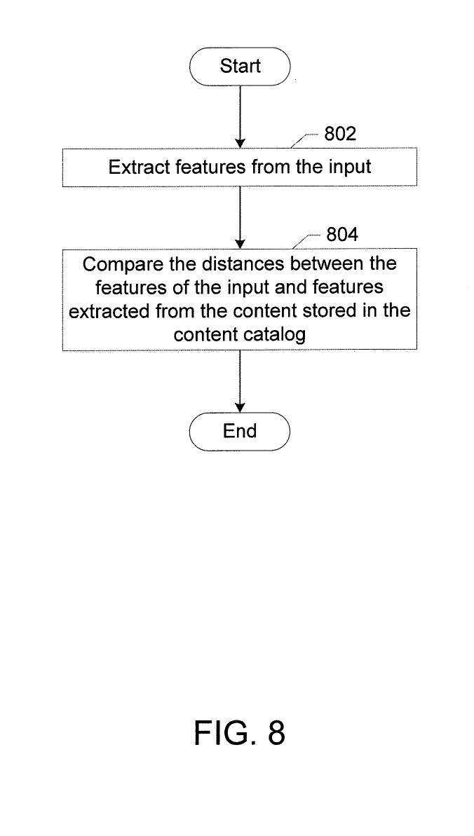

Returning now to FIG. 2, in operation 204, the apparatus 100 may further include means, such as processor 104 or the like, for identifying content that matches the input. For instance, with a sketch (e.g., a full shot with two persons) received through the user interface, the processor may be configured to identify a video key frame or still image that best matches the sketch. The manner in which a best match is determined may be predefined and may be based upon one or more parameters, such as, e.g., number of persons, close-up vs. wide-angle. The processor may then analyze the content based on the one or more parameters. This identifying operation may be repeated by the processor for all input sketches. Example operations to identify such content will be discussed in greater detail below in conjunction with FIGS. 7 and 8.

Thereafter, the final video remix may be cut or otherwise created by joining together the selected shots. In particular, in operation 206, the apparatus 100 may include means, such as processor 104 or the like, for generating a media compilation based on the identified input. In this regard, to generate a media compilation using video content, the apparatus 100 may include media mixing means, such as processor 104, or the like, for creating the media compilation based on identified video and/or image content that best matches the input as well as identified transition effects content that matches the input.

The apparatus 100 may include means, such as processor 104 or the like, for analysing sensory data of the identified video and/or image content to locate interesting points in time during the event. To identify interesting points in time during the event the apparatus 100 may include means, such as processor 104 or the like, for using audio alignment to find a common timeline for all identified video content. In addition, the apparatus 100 may include means, such as processor 104 or the like, for executing dedicated sensor data (e.g., accelerometer, compass, etc.) analysis algorithms to determine whether the identified videos and/or images capture the same location on a stage. An interesting point in time during an event may be a time when a predetermined amount of content recording a given point in time captures the same location on a stage. Furthermore, the apparatus 100 may include means, such as processor 104 or the like, for analysing music content (e.g., beats, downbeats, etc.) included in the identified videos to find a temporal grid of potential cut points in the event sound track. Based thereon, the media compilation may switch between different sources of media in the final compilation.

In addition, based on the transition effects content, the apparatus 100 may include means, such as processor 104 or the like, for producing appropriate frame transition effects (e.g., a sharp transition, a blurry transition, or a looping transition sequence, etc.).

In some embodiments, the duration of each segment of the media compilation may also be defined based upon input provided by the user through the interface. Alternatively, the duration may be determined automatically by the apparatus 100, such as the processor 104, based on, for example, the above analysis of the audio events associated with the audio track of the media compilation. As yet another alternative, the duration of a shot may be determined by the apparatus, such as the processor, based upon when a shot matching the next sketch is encountered in the content catalog.

Turning now to FIG. 7, a flowchart is shown that describes example embodiments for identifying content that matches the input. In one embodiment, the apparatus 100 may include means, such as the processor 104 or the like, for comparing the input to content stored in the content catalog. See operation 702. In this regard the input may be visually compared by the processor to images or video key frames stored in the content catalog for visual matching. Such visual matching can be done, for example, by calculating distances between user sketches and edges detected from the visual content with edge detection means (example operations of which are discussed in greater detail below in conjunction with FIG. 8). However, although visual matching may be used to identify content, in some situations, the needs of the user may be better served by other procedures for content identification, based on computational constraints, when a different degree of matching accuracy is required, or based on the user's preference of content identification procedures.

Accordingly, in another embodiment, the apparatus 100 may, in operation 704, include means, such as the processor 104 or the like, for determining a keyword associated with the input based on an analysis of the input. In this embodiment, the apparatus 100 may include means, such as the processor 104 or the like, for identifying content that has previously been associated with the keyword. See operation 706. In other words, the input may be interpreted and described using one or more keywords. Of course, in this embodiment the content in the content catalog will have previously been analyzed and described using keywords. Accordingly, in this embodiment, the processor compares the keywords associated with the input to keywords associated with content in the content catalog and identifies the best match between the input and the content. Thus, keyword matching may alter the computational load of the identification operation and/or may identify matching content with a different degree of accuracy.

In yet another embodiment, the apparatus 100 may include means, such as the processor 104 or the like, for identifying content using a combination of the procedures of operations 702, 704, and 706. If all matching content found using either procedure is identified, using of a combination of both procedures may identify the greatest breadth of content for use in generating the media compilation. Alternatively, if content is only identified when matched using both procedures, using a combination of procedures may provide the greatest degree of matching accuracy. For background image matching, location and heading metadata associated with a chosen photo may be utilized by the apparatus, such as the processor, to find the match.

Turning now to FIG. 8, a flowchart is shown that describes example operations for comparing the input to content stored in the content catalog. In operation 802, the apparatus 100 may include means, such as the processor 104 or the like, for extracting features from the input. The features may relate, for example, to edges detected from the input and may be detected using edge detection means, such as processor 104 or the like. In the case of drawn user input, the apparatus 100 may detect features by tracking the location of the user pointing device or finger on the screen for a predetermined time, or by performing binarization of an input image where features are depicted using a color and the background is white.

In operation 804, the apparatus 100 may include means, such as the processor 104, memory 108 or the like, for comparing the distances between the features of the input and features extracted from the content stored in the content catalog. In this regard, features from the content in the content catalog may be extracted as a pre-processing step that needs to be done only once for each item in the content catalog. For instance, the apparatus extracts the features from new content when storing new content in the content catalog to enable its use in a subsequent comparison. Accordingly, when new user input is received, the apparatus 100 may extract the features only for the new user input, and the comparison of the features from the user input is done against the features which have previously been extracted from the content in the content catalog. Of course, alternative embodiments (such as the simultaneous extraction of features from the input and the content in the content catalog) are also possible.

The purpose of the distance comparison step is to find the content in the content catalog which provide the closest distances to the features of the input. The content in the content catalog which correspond to the closest distances may be the content which most closely match the provided input, and are thus the best candidates to be included in the media compilation. In this regard, the apparatus 100 may include means, such as the processor 104 or the like, for matching the features of the input to features of the content in the content catalog. The matching can be done using known methods for query-by-sketch, for example, by matching detected user strokes to the edge information detected from visual content.

As an example, the apparatus 100 may detect features corresponding to user strokes from a user input depicting a person. The user strokes are then compared to shapes extracted from the media items in the content catalog, for example, using similar edge detection means. Distances between the shape drawn by the user and the shapes detected from media items in the content catalog are calculated. The media items which contain shapes which most closely (with smallest distance) match the user provided shape (the person shape) are the best candidates to be included in the media compilation.

In one embodiment, the processor may include or otherwise be associated with a content matching module configured to match the features and edges of the input to content from the content catalog. The process, such as the content matching module of one embodiment, may return a sorted list of best matches from the catalog. Similarly, the apparatus 100 may include means, such as the processor 104 or the like, for recognizing user requested effects based on the input. For example, the processor may include or otherwise be associated with an effect matching module configured to recognize the user requested effects. For example, the apparatus 100 may extract the strokes drawn by the user indicating the requested effect, and then match these strokes against a catalog of exemplary strokes which represent different effects.

Although the above embodiments are described in connection with generating a media compilation, in one embodiment of the invention, the sketching input can also be used as a method for searching (e.g., fast-forwarding) for a specific shot in the content catalog. For example, the apparatus 100 may include means, such as the processor 104, the user interface 102 or the like, for enabling a user to draw a sketch of a close-up scene, and then presenting a first shot with a close-up. If the user taps the screen, the user interface 102 may scroll to the next close-up (e.g., the next closest content from the content catalog matching the user's sketch).

In some embodiments, to avoid challenges associated with individual drawing styles, the apparatus 100 may include means, such as the processor 104, the user interface 102 or the like, for providing the user with a training period during which the user draws examples of sketches that the user wants to be used to represent different angle types and/or effects.

In other embodiments, sketches inputted by some users to query the content catalog, and the resulting matching video key frames, are utilized in sketch-analysis of subsequent users. In this fashion, the apparatus 100 may increase the accuracy of future matches of content to user sketches, by learning what visual content the users eventually selected. Initially, the apparatus may provide a (e.g., sorted) list of best matching video key frames/images, and the user makes the final selection. The actual user selections are stored by the apparatus in memory 106 and used for improving similar sketch queries in the future. In a similar manner, the system may learn more examples for the different effects by collecting features of the inputs for effects from different users.

As described above, FIGS. 2, 7, and 8 illustrate flowcharts of the operation of an apparatus, method, and computer program product according to example embodiments of the invention. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 108 of an apparatus employing an embodiment of the present invention and executed by a processor 104 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the functions specified in the flowchart blocks. The computer program instructions may also be loaded onto a computer or other programmable apparatus to cause a series of operations to be performed on the computer or other programmable apparatus to produce a computer-implemented process such that the instructions executed on the computer or other programmable apparatus provide operations for implementing the functions specified in the flowchart blocks.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which preform the specified functions, or combinations of special purpose hardware and computer instructions.

In some embodiments, certain ones of the operations above may be modified or further amplified. Furthermore, in some embodiments, additional optional operations may be included. Modifications, amplifications, or additions to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving input that visually simulates a desired type of content;
identifying, by a processor, content that matches the input; and
generating a media compilation based on the identified content.

2. The method of claim 1, wherein identifying content that matches the input includes at least one of:
comparing the input to content stored in a content catalog; and
determining a keyword associated with the input based on an analysis of the input, and identifying content that has previously been associated with the keyword.

3. The method of claim 2, wherein comparing the input to content stored in the content catalog includes:
extracting features from the input; and
comparing the distances between the features of the input and features extracted from the content stored in the content catalog.

4. The method of claim 1, further comprising:
receiving an indication of a duration of a frame in the media compilation.

5. The method of claim 1, wherein the desired type of content comprises a shot type, a number of people appearing in a shot, a primary shape of an object that appears in a shot, or a transition effect.

6. The method of claim 1, wherein the input comprises a sketch drawn by a user or a captured image.

7. The method of claim 1, wherein the media compilation comprises a video remix, a slideshow, or a combination of both.

8. An apparatus comprising at least one processor and at least one memory including computer program code, the at least one memory and the computer program code configured to, with the at least one processor, cause the apparatus to:
receive input that visually simulates a desired type of content;
identify content that matches the input; and
generate a media compilation based on the identified content.

9. The apparatus of claim 8, wherein the at least one memory and the computer program code are configured to, with the at least one processor, cause the apparatus to identify content that matches the input by at least one of:
comparing the input to content stored in a content catalog;
determining a keyword associated with the input based on an analysis of the input, and identifying content that has previously been associated with the keyword.

10. The apparatus of claim 9, wherein the at least one memory and the computer program code are configured to, with the at least one processor, cause the apparatus to compare the input to content stored in the content catalog by:
extracting features from the input; and
comparing the distances between the features of the input and features extracted from the content stored in the content catalog.

11. The apparatus of claim 8, wherein the at least one memory and the computer program code are configured to, with the at least one processor, cause the apparatus to:
receive an indication of a duration of a frame in the media compilation.

12. The apparatus of claim 8, wherein the desired type of content comprises a shot type, a number of people appearing in a shot, a primary shape of an object that appears in a shot, or a transition effect.

13. The apparatus of claim 8, wherein the input comprises a sketch drawn by a user or a captured image.

14. The apparatus of claim 8, wherein the media compilation comprises a video remix, a slideshow, or a combination of both.

15. A computer program product comprising at least one non-transitory computer-readable storage medium having computer-executable program code portions stored therein, the computer-executable program code portions comprising program code instructions that, when executed, cause an apparatus to:
receive input that visually simulates a desired type of content;
identify content that matches the input; and
generate a media compilation based on the identified content.

16. The computer program product of claim 15, wherein the computer program product further comprises program code instructions that, when executed, cause the apparatus to identify content that matches the input by at least one of:
comparing the input to content stored in a content catalog; and
determining a keyword associated with the input based on an analysis of the input, and identifying content that has previously been associated with the keyword.

17. The computer program product of claim 16, wherein the computer program product further comprises program code instructions that, when executed, cause the apparatus to compare the input to content stored in the content catalog by:
extracting features from the input; and
comparing the distances between the features of the input and features extracted from the content stored in the content catalog.

18. The computer program product of claim 15, wherein the desired type of content comprises a shot type, a number of people appearing in a shot, a primary shape of an object that appears in a shot, or a transition effect.

19. The computer program product of claim 15, wherein the input comprises a sketch drawn by a user or a captured image.

20. The computer program product of claim 15, wherein the media compilation comprises a video remix, a slideshow, or a combination of both.
